(19) United States
(12) Patent Application Publication
(10) Pub. No.: US 2009/0205959 A1
(43) Pub. Date: Aug. 20, 2009

(54) AUTOMATIC SAMPLE PROCESSING METHOD AND AUTOMATIC SAMPLE PROCESSING APPARATUS FOR LID-SEALED MICROCHIPS FOR BIOANALYSIS

(75) Inventors: Machiko Fujita, Tokyo (JP); Hisao Kawaura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku (JP)

(21) Appl. No.: 11/815,837

(22) PCT Filed: Feb. 8, 2006
(86) PCT No.: PCT/JP2006/302116

§ 371 Date: Aug. 8, 2007

(30) Foreign Application Priority Data
Feb. 10, 2005 (JP) 2005-034821
Feb. 3, 2006 (JP) 2006-026888

(51) Int. Cl. G01N 27/447; B01D 57/02

(52) U.S. Cl. 204/452; 204/451; 204/455; 204/602

(57) ABSTRACT

The present invention provides a technique for automating the operation to peel off and remove a lid seal part adhered and fixed to the top face of a substrate part constituting a lid-sealed “microchip” after subjecting a sample solution to be analyzed to electrophoretic separation. After subjecting sample solution to be analyzed to desired electrophoretic separation the by utilizing a channel formed in the lid-sealed microchip, the electrophoretically separated liquid sample held in the channel undergoes freezing of the aqueous solvent contained and then, while the whole electrophoretically separated liquid sample remains sustained in the frozen state, an end of the lid seal part used for sealing the top face of channel formed in the substrate part is lifted up at a predetermined speed so as to peel and remove it from the substrate part under a condition of maintaining a bend of a predetermined radius of curvature.

### TECHNICAL FIELD

The present invention relates to a method for automation of processing of a sample to be analyzed in a lid-sealed microchip in the case where the lid-sealed microchip for bio-analysis is to be used, an automatic sample processing apparatus based on that method and biosubstances analyzing apparatus to which the automatic sample processing method is applied. More particularly, it relates to a method for automating the operation to remove the lid seal and then process the sample to be analyzed in the lid-sealed microchip and an automatic sample processing apparatus adapted to that automated processing method.

### BACKGROUND ART

Regarding a sample containing biosubstances, when any protein or nucleic acid substance contained in the sample is to be identified, various electrophoretic techniques are used. Especially in such a case where the absolute quantity of the sample is small, a capillary electrophoresis method, in which electrophoresis is carried out in a capillary tube having a very small bore size, is extensively used as an electrophoretic technique manifesting excellent separating performance, for which the quantity of the sample used is very small. There has been proposed such a technique in which, instead of a capillary tube having a very small bore size, a groove-shaped channel having an arrangement of channel with a desired planar pattern, whose channel width and depth are set 100 μm or less for the section shape thereof, is formed on a substrate, and a lid seal, which performs the function of a lid over these channels, is provided therein so that the resulted portion of groove-shaped channels is utilized as a capillary space (Patent Document 1). This substrate provided with a channel usable as a capillary space and its lid seal are combined with each other in a predetermined arrangement, and stuck to each other, together to be used as a lid-sealed “microchip”. When electrophoresis is carried out in such a lid-sealed “microchip”, a plurality each of proteins and nucleic acid substances contained in the sample are separated from one another along the channel, because of differences in the properties such as electrophoretic velocity, which show a plurality of spots, each corresponding to the type of each substance. It is also possible to employ such a modification in which a plurality of groove-shaped channels are formed in a lid-sealed “microchip” to work out a shape having a plurality of lanes (electrophoretic paths), and in this case, a state in which the different lanes (electrophoretic paths) are physically separated from one another is achieved by sealing the top face of each groove-shaped channel with the lid seal.

After carrying out the operation for electrophoretic separation, which is equivalent to a capillary electrophoresis, by using a lid-sealed “microchip”, operation of measurement is carried out to detect the positions of spots separated along that channel. For instance, it is possible to provide a plurality each of proteins and nucleic acid substances to be electrophoretically separated with labels in advance and to detect such labels to locate the positions of spots separated along the channel. More specifically, there is proposed a device for microchip electrophoresis having such a style in which fluorescent labeling is used as a mark to optically detect the spots (Patent Document 1: JP 10-246721 A). This microchip electrophoretic device is composed of such systems as an exciting light source and an optical detector used for optical detection of fluorescent labels, a microchip moving system used for such purposes as determination of optically detected positions along channels, an electrophoretic liquid injecting system and a sample injecting system used for injecting the electrophoretic liquid and sample into each channel in the microchip, a power supply device for electrophoretic separation and a CPU board used for controlling the actions thereof. Incidentally, in order to use such a method that optical detection is made by utilizing fluorescent labels for marking, the lid-sealed “microchip” is fabricated by forming groove-shaped channels in a substrate made of a light-transmissive material, such as a transparent glass, and the base member used for lid sealing is provided with an electrode mount for applying a bias to each groove-shaped channel at the time of electrophoresis. After the electrophoresis, detection of the spots is carried out for each of the groove-shaped channels, in which the liquid is held

There has been proposed an apparatus in which, after carrying out operation of electrophoretic separation, which is equivalent to capillary isoelectric focusing, by using a lidded “microchip”, information on the spot positions and molecular weights for the proteins separated along its channels is collected by applying MALDI-MS (matrix-assisted laser desorption/ionization mass spectrometry) (Non-Patent Document 1: Michelle L.-S. Mok et al., Analyst, Vol. 129, 109-110 (2004), Patent Document 2: WO 03/071263 A1). It has a constitution in which, in order to avoid heating of the liquid in the micro-channel by the high voltage applied accompanying the isoelectric focusing and resultant evaporation of the solvent, the “microchip” itself is cooled over a thermoelectric cooler to control the temperature and the top face of each groove-shaped channel is tightly covered by sealing with the lid. After finishing the operation of the electrophoretic separation, the lid is removed, and the solvent in each groove-shaped channel is quickly evaporated by heating the substrate or placing it in a vacuum so as to dry and solidify the separated proteins at each spot. In a state in which the separated proteins are held over the microchip, a suitable matrix material is added into this groove-shaped channel, and then MALDI-MS measurement is carried out along the channels to detect each of spots.

In a case where the lid-sealed “microchip” is made in such a form that the lid seal and the substrate part are integrated and thus the lid seal cannot be peeled off, it is necessary, in the same way as where a conventional capillary is used, to take out after the electrophoretic separation the substances separated in the channel with driving means such as a pump while avoiding remixing and to offer them for various mass analyses (Non-Patent Document 2: Daria Peterson et al., “A New Approach for Fabricating a Zero Dead Volume Electrospray Tip for Non-Aqueous Microchip CE-MS”, Micro Total Analysis Systems 2002, Vol. 2, pp. 691-693 (2002)). Further, in the case where an individual sample separated is to be transferred to an individual sample holder therefor after being taken out of channels in the “microchip”, in addition to MALDI-MS, Electrospray ionization mass spectrometry (ESI-MS) is applicable as a method of mass analysis.

Patent Document 1: JP 10-246721 A

Patent Document 2: WO 03/071263 A1

Non-Patent Document 1: Michelle L.- S. Mok et al., Analyst, Vol. 129, 109-110 (2004)

Non-Patent Document 2: Daria Peterson et al., “A New Approach for Fabricating a Zero Dead Volume Electrospray Tip for Non-Aqueous Microchip CE-MS”, Micro Total Analysis Systems 2002, Vol. 2, pp. 691-693 (2002)

### DISCLOSURE OF THE INVENTION

### Problems to be Solved by the Invention

In order to further expand the range of applications of lid-sealed “microchips”, the following two functions are desired in the case where a plurality of groove-shaped channels are formed in a lid-sealed “microchip” to work out a shape having a plurality of lanes (electrophoretic paths):

different lanes (electrophoretic paths) can be physically separated from one another by sealing the top face of each groove-shaped channel with the lid seal; and

on the other hand, after the completion of the operation for electrophoretic separation, the lid seal part can be easily detached from the substrate part, and then operation of further analysis for the separated substances can be performed in each of the lanes (i.e. channels for electrophoresis).

On achieving a constitution in which the top face of a groove-shaped channel formed in the substrate part are tightly covered by sealing with the lid seal for a lid-sealed “microchip”, such a tightly sealed channel is suitable for the operation for electrophoretic separation, which is equivalent to the conventional electrophoresis using a capillary. As a way to construct such a tightly sealed channel, it is desirable to place the top face of the substrate part in which the groove-shaped channel is formed and the bottom face of the lid seal part in a more solidly stuck state by using heat sealing or an adhesive layer. On the other hand, in the case where a more solidly stuck state is attained, in order to induce the peeling off between the top face of the substrate part and the bottom face of the lid seal part and then remove the lid seal part, an external force is applied to the lid seal part so as to forcibly peel it off, but this process might invite minute mechanical vibration. This minute mechanical vibration could promote mixing within the liquid present in the groove-shaped channels, and thus it may be a cause which stimulates, for instance, re-diffusion of the target substance separated as narrow spots in the groove-shaped channel. Further, during the time taken to conduct the removal of the lid seal part, as diffusion due to the concentration gradient within the liquid also progresses, re-diffusion of the target substance separated as narrow spots in the groove-shaped channel would occur to a certain extent.

In addition, when carrying out electrophoretic separation by using the channel formed in the lid-sealed “microchip”, it is by no means rare for the liquid to come into contact with the bottom face of the lid seal part, which seals the top face of the substrate part, in addition to contact with the wall faces of the groove-shaped channel formed in the substrate part. In such a case, a small portion of the liquid in contact with the bottom face of the lid seal part is caused to stick to the bottom face of the lid seal part by the wetness of the liquid, when the lid seal part is peeled and removed. After that, this small quantity of liquid may run down the bottom face of the lid seal part, form accumulated liquid drops, and then the drops drips again into the channels. In the area where these accumulated liquid drops drip again, if the liquid drops having fallen mix with the liquid which has already been there will run into a state exposed to “external interference” different from the true state of separation.

In the lid-sealed “microchip”, the top faces of the groove-shaped channels formed in the substrate part of a lid-sealed “microchip” are tightly covered by sealing with the lid seal part, and thus when a plurality of groove-shaped channels are formed on the “microchip” to make it up in a shape having a plurality of lanes (channels for electrophoresis), different lanes (channels for electrophoresis) are placed in a state in which they are physically separated from one another, and thereby infiltration of the liquid between the lanes (channels for electrophoresis) and leaking of the liquid, evaporation of the solvent and invasion of foreign substance are well avoided. However, it is further desired to restrain such phenomena as re-diffusion of the separated target substance attributable to the very action of peeling and removing the lid seal part and “endogenous contamination” resulting from a small quantity of liquid stuck to the bottom face of the lid seal part.

Moreover, if the operation for peeling and removal of the lid seal part is manually carried out, the length of time taken fluctuates with the skill level of the worker, and it is desired with a view to achieving high reproducibility to make the operation for peeling and removal of the lid seal part achievable by an automatic process.

The present invention will solve the problems stated above, and thus an object of the present invention is to provide a sample processing method, and an automatic sample processing apparatus based on such an automatic sample processing method, in which method, after subjecting a sample liquid to be analyzed to the operation for electrophoretic separation using a lid-sealed “microchip”, the operation of peeling and removal of the lid seal part stuck and fixed to the top face of the substrate part, which compose the lid-sealed “microchip”, can be carried out with a high level of reproducibility by using the automated apparatus, while restraining re-diffusion of the separated target substance and the phenomenon of “endogenous contamination” resulting from a small quantity of liquid stuck to the bottom face of the lid seal part.

### Means for Solving the Problems

The present inventors engaged in intensive research to solve the problems noted above, and obtained the series of findings described below.

First, they noticed that the two phenomena of “re-diffusion of the target substance”, which are the mixing of liquid by minute mechanical vibration caused by the very action of peeling and removing the lid seal part and the diffusion of the concentration resulting from the concentration gradient of the separated target substance, were phenomena incident to such situation that the substance is held as a solution in the channel formed in the lid-sealed “microchip” even after completion of the operation of electrophoretic separation. Thus, the inventors discovered that placing in a solid phase state in which internal migration of substances was difficult, instead of keeping the solution state, would prevent substantially the two phenomena of “re-diffusion of the target substance”. Specifically, it was found that, after completion of the operation of electrophoretic separation, the operation for rapidly cooling the solution held in that channel is carried out to freeze the aqueous solvent contained therein and then the operation for peeling and removing the lid seal part is performed while keeping this frozen state, whereby both the mixing of liquid by minute mechanical vibration and the diffusion of the concentration due to the concentration gradient of the separated target substance could be avoided.

Furthermore, in the step of peeling and removing the lid seal part, peeling proceeds while inevitably giving rise to a transient narrow gap between the top face of the substrate part and the bottom face of the lid seal part. In the case if part of the solution held in those channels then infiltrates into this narrow gap, it may cause sometimes the leak to be increased by a capillary effect along the interface between the top face of the substrate part and the bottom face of the lid seal part where the peeling is proceeding. As the result, there are a considerable possibility that “Mutual contamination” by partial infiltration of the liquid between adjoining lanes (channels for electrophoresis) will occur. In the case where the electrophoretically separated sample in the channels formed in the “microchip” is kept in a frozen state, when a narrow gap transiently occurs between the top face of the substrate part and the bottom face of the lid seal part in the step of peeling and removing the lid seal part, even the phenomenon of partial infiltration of the liquid held in those channels from arising would be essentially prevented. Accordingly, it was also found out that any restrictions would substantially removed in the duration of the transient narrow gap between the top face of the substrate part and the bottom face of the lid seal part and in the spacing and width of the transient narrow gap in the step of peeling and removing the lid seal part.

Finally, regarding the phenomenon of “endogenous contamination” deriving from a small quantity of liquid stuck to the bottom face of the lid seal part as well, the inventors also found that, in the case where, after the operation for freezing the aqueous solvent contained therein was carried out in advance, this frozen state was maintained, the wetness of the liquid on the surface of the bottom face of the lid seal part no longer comes into any question. On the other hand, the top face of the sample in the frozen state and the surface of the bottom face of the lid seal part are in contact with each other, and it is necessary to carry on the peeling and removal of the lid seal part under such conditions as to allow the sample in the frozen state to be satisfactorily separated from the surface of the bottom face of the lid seal part. It is required to conduct the peeling and removing of the lid seal part by selecting conditions under which the adhesive strength of the sample in the frozen state to the surface of the bottom face of the lid seal part does not cause fragments partially coming off the sample in the frozen state to leave on the surface of the bottom face of the lid seal part.

The present inventors had studied under what circumstances fragments partially coming off the sample in the frozen state would be left on the surface of the bottom face of the lid seal part. After that, the present inventors have found that the lid seal part is temporally in a state of being bent at a certain radius of curvature R at the site where the top face of the sample in the frozen state comes into contact with the surface of the bottom face of the lid seal part, of which peeling is proceeding, namely in the narrow gap part transiently arising between the top face of the sample in the frozen state and the bottom face of the lid seal part in the step of peeling and removing the lid seal part; and if a condition where the radius of curvature R is smaller than a certain threshold R_{eq1} (R<R_{eq1}) is selected, there no longer occur any fragments coming off the sample in the frozen state being left thereon. It has further been revealed that the threshold R_{eq1} is determined dependent on Young's modulus E of the material constituting the lid seal part, the per-unit area adhesive strength p₁ of the sample in the frozen state to the bottom face of the lid seal part and the shearing stress level, above which fragmentation of the sample in the frozen state occurs.

On the basis of the aforementioned findings, the present inventors have verified the following facts, and thereby have completed the present invention:

after carrying out the operation of desired electrophoretic separation for a liquid sample to be analyzed by utilizing a channel formed in a lid-sealed microchip,

while maintaining the sample having gone through electrophoretic separation in the sustained frozen state in the groove-shaped channel formed in the substrate part, the operation of detaching a lid seal part, which is so far stuck and fixed to the top face of the substrate part in the lid-sealed microchip seals the top face of the groove-shaped channel formed in the substrate part, can be conducted through the steps of:

subjecting the liquid sample having gone through electrophoretic separation and held in the channel to an operation to freeze the aqueous solvent that is contained therein, and

performing an operation to peel and remove from the substrate part the lid seal part which seals the top face of the groove-shaped channel formed in the substrate part, while maintaining the sample having gone through electrophoretic separation in the sustained frozen state in the channel; and further

the foregoing series of operations can be automated.

Hence, an automatic sample processing method for lid-sealed microchips for bioanalysis according to the present invention is:

a method for automatically processing, after subjecting a liquid sample to be bioanalyzed to a desired operation of electrophoretic separation by utilizing a channel formed in a lid-sealed microchip, the liquid sample having gone through electrophoretic separation and held in the channel, characterized in that:

said lid-sealed microchip has a constitution in which a groove-shaped channel formed in the substrate part thereof and a lid seal part sealing the top face of the substrate part have achieved a state of being adhered together in a predetermined arrangement so that the top face of the substrate part and the bottom face of the lid seal part are tightly adhered to each other,

after completing the desired operation of electrophoretic separation of the liquid sample to be analyzed by utilizing the channel formed in the lid-sealed microchip, the method comprises the following steps:

a step of cooling in which the liquid sample having gone through electrophoretic separation and held in the channel is subjected to an operation to freeze the aqueous solvent that is contained therein by cooling the substrate part of said lid-sealed microchip to achieve a predetermined low temperature condition at or below the ice point;

a step of peeling the lid seal part off in which, while maintaining the sample having gone through electrophoretic separation in a sustained frozen state in the channel by keeping the substrate part of said lid-sealed microchip cooled to said predetermined low temperature,

an operation to peel and remove the lid seal part from the substrate part is carried out by applying an external force to an end of the lid seal part so as to release the adhesive strength which has brought the top face of the substrate part and the bottom face of the lid seal part into tight contact and achieved an adhered state in a predetermined arrangement and thereby to peel the bottom face of the lid seal part off the top face of the substrate part while maintaining a condition in which a radius of curvature R representing a local bend of the lid seal part on a boundary where the peeling is proceeding, relative to a predetermined threshold R_{eq1}, is kept smaller than said threshold R_{eq1} (R<R_{eq1}); and

a step of detaching the lid seal part in which, after said peeling step is ended, in the lid-sealed microchip, the lid seal part which has been separated from the top face of the substrate part by releasing the adhesive fixation thereto is detached, and then the separated lid seal part is subjected to an operation for conveying it away and holding so as to attain such a state that the surface of the electrophoretically separated sample in a sustained frozen state is exposed in the groove-shaped channel formed in the substrate part; and

the series of these steps being automatically accomplished.

Incidentally, the automatic sample processing method for lid-sealed microchips for bioanalysis according to the present invention may as well have such a constitution that the method is characterized by:

after completing the process for removing a lid seal part,

the method further comprises:

a step for lyophilization and fixing, in which the electrophoretically separated sample maintained in the sustained frozen state in the groove-shaped channel formed in the substrate part is subjected to lyophilization to fix each of the ingredient substances, which is separated at each point of spots on said channel formed in the substrate part, in the form of freeze-dried matters on the pertinent spots.

Further, an automatic sample processing apparatus for a lid-sealed microchip for bioanalysis according to the present invention is:

an apparatus for automatically processing, after subjecting a liquid sample to be bioanalyzed to a desired operation of electrophoretic separation by utilizing a channel formed in a lid-sealed microchip, the liquid sample having gone through electrophoretic separation and held in the channel, characterized in that:

said lid-sealed microchip has a constitution in which a groove-shaped channel formed in the substrate part thereof and a lid seal part sealing the top face of the substrate part have achieved a state of being adhered together in a predetermined arrangement so that the top face of the substrate part and the bottom face of the lid seal part are tightly adhered to each other,

the apparatus comprises the following systems to be provided for the lid-sealed microchip in which the desired operation of electrophoretic separation of the liquid sample to be analyzed has been completed by utilizing the channel formed in the lid-sealed microchip: a system for refrigerating the substrate part, which system is adapted for installation in an arrangement in contact with the substrate part of said lid-sealed microchip;

a control unit for the refrigerating system, which unit is capable of maintaining at least the substrate part in a predetermined low temperature condition of at or below the ice point by cooling down by means of the system for refrigerating the substrate part to be installed in the arrangement in contact with the substrate part;

a system for fixing the substrate part, which system is capable of fixing the substrate part of said lid-sealed microchip in the arrangement in contact with said system for refrigerating the substrate part;

a system for imposing an external force, which system has a function to impose on an end of the lid seal part an external force having a substantially perpendicular direction to the top face of the substrate part in the arrangement in which the substrate part is fixed by said system for fixing the substrate part in order to release the adhesive strength which has brought the top face of the substrate part and the bottom face of the lid seal part into tight contact and achieved an adhered state in a predetermined arrangement;

a system for transferring the end of the lid seal part, which system is capable of transferring the end of the lid seal part in a direction substantially perpendicular to the boundary of contact between the top face of the substrate part and the bottom face of the lid seal part in synchronism with the imposition of the external force on the end of the lid seal part by said system for imposing the external force;

a system for controlling a speed of transferring the end of the lid seal part, which has a function to control the transfer speed of the end of the lid seal part so that, in the process of peeling the bottom face of the lid seal part off the top face of the substrate part by using the system for transferring the end of the lid seal part and the system for imposing the external force, which systems works in synchronism on the end of said lid seal part, a radius of curvature R representing a local bend of the lid seal part on a boundary where the peeling is proceeding is maintained in such condition that, relative to a predetermined threshold R_{eq1}, the radius of curvature R is kept smaller than said threshold R_{eq1} (R<R_{eq1});

a system for detaching the separated lid seal part, which system has such a function that, after the operation to peel the lid seal part off the top face of the substrate part is ended, the system holds the lid seal part which is separated from the top face of the substrate part by releasing the adhesive fixation and conveys it away from the top face of the substrate part so as to expose the groove-shaped channel formed in the substrate part; and

the apparatus further comprises a system for controlling an automatic operation thereof, which system has a function to cause the actions of each of the systems accomplishing the series of operations set forth to be automatically accomplished in accordance with a predetermined process program.

Also, the automatic sample processing apparatus for lid-sealed microchips for bioanalysis according to the present invention may have such a constitution that the apparatus is characterized by:

in addition to each of systems described above,

the apparatus further comprises,

a system for lyophilization and fixing, with use of which system, the electrophoretically separated sample maintained in the sustained frozen state in the groove-shaped channel formed in the substrate part is subjected to lyophilization in a state in which the groove-shaped channel formed in the substrate part is exposed by conveying the separated lid seal part away from the top face of the substrate part by using the system for detaching the lid seal part, so that each of the ingredient substances, which is separated at each point of spots on said channel formed in the substrate part, is fixed in the form of freeze-dried matters on the pertinent spots.

In addition, the present invention further provides an invention of a method for analysis of a biosample, in which, by applying the automatic sample processing method for lid-sealed microchips for bio-analysis according to the present invention, which method has such constitutions as mentioned above, peeling and removing the lid seal part, with which the top face of the substrate part has been tightly covered by sealing, is carried out after the completion of operation for electrophoretic separation using the lid-sealed microchip, and then operation for mass analysis is performed to the electrophoretically separated sample, which is maintained in a sustained frozen state in the groove-shaped channel formed in the substrate part whose surface is exposed by the processing.

Thus, a biosample analyzing method according to the present invention is:

a method for analyzing bio-sample, which is a method in which, after subjecting a liquid sample to be bio-analyzed to a desired operation of electrophoretic separation by utilizing a channel formed in a lid-sealed microchip, regarding ingredient substances being spot-separated on said channel, which are contained in the electrophoretically separated liquid sample held on the channel formed in the lid-sealed microchip, mass analysis of the ingredient substances spot-separated is carried out, characterized in that:

said lid-sealed microchip has a constitution in which a groove-shaped channel formed in the substrate part thereof and a lid seal part sealing the top face of the substrate part have achieved a state of being adhered together in a predetermined arrangement so that the top face of the substrate part and the bottom face of the lid seal part are tightly adhered to each other,

the method comprising:

a step of collection, in which, after completing the desired operation of electrophoretic separation of the liquid sample to be analyzed by utilizing the channel formed in the lid-sealed microchip,

the lid seal part, with which the top face of the substrate part is tightly covered by sealing, is peeled and removed out in accordance with the method for automatic sample processing for lid-sealed microchips for bio-analysis of the present invention, which method has such constitutions as mentioned above, and then

the electrophoretically separated sample, which is maintained in a sustained frozen state in the groove-shaped channel formed in the substrate part whose surface is exposed thereby, is collected;

a step for lyophilization and fixing, in which the electrophoretically separated sample maintained in the sustained frozen state in the groove-shaped channel formed in the substrate part is subjected to lyophilization to fix each of the ingredient substances, which is separated at each point of spots on said channel formed in the substrate part, in the form of freeze-dried matters on the pertinent spots;

a step for providing a matrixing agent, in which the matrixing agent used for MALDI-MS analysis is coated on the groove-shaped channel formed in the substrate part to provide said matrixing agent to the electrophoretic separated ingredient substances, fixed on the spots in the form of freeze-dried matters;

a step for MALDI-MS analyzing, in which MALDI-MS analytical operation along the groove-shaped channel formed in the substrate part is carried out by using said matrixing agent to acquire molecular weight information on ion species deriving from the electrophoresized ingredient substances fixed in the form of freeze-dried matters on the pertinent spots and positional information on the spots showing the molecular weight information of the ion species, and

a step for data analyzing, in which specifying electrophoretic index values corresponding to the spots is carried out on the basis of the acquired positional information for the spots showing the molecular weight information of the ion species, and then the information is converted into combinations of the specified electrophoretic index values specified and the molecular weight information of ion species measured at the pertinent spots, which are presumably derived from the ingredient substances contained in the liquid sample to be analyzed, being located along the groove-shaped channel.

### Effects of the Invention

By utilizing the automatic sample processing method for lid-sealed microchips for bioanalysis and the automatic sample processing apparatus for lid-sealed microchips for bioanalysis according to the present invention, the operation for peeling and removing the lid seal part stuck and fixed to the top face of the substrate part, which parts compose the lid-sealed “microchip”, after the operation of electrophoretic separation for a sample liquid to be analyzed is performed by using the lid-sealed “microchip”, can be automated with a high level of reproducibility while restraining re-diffusion of the separated target substance and the phenomenon of “endogenous contamination” caused by a small quantity of liquid stuck to the bottom face of the lid seal part. In addition, post to the operation for peeling and removal of the lid seal part, which is automated with a high level of reproducibility, the operation of sample preparation, which is carried out in advance for a further analysis, such as mass analysis, by using the sample having gone through electrophoretic separation, can be also automated. Therefore, even if the number of sample liquids to be analyzed to be subjected to electrophoretic separation becomes great, high level of reproducibility of the process, in which the samples having gone through electrophoretic separation is subjected to the sample processing in order to provide the prepared samples to a further analysis, can be attained by applying the present invention thereto.

### BRIEF DESCRIPTION OF THE DRAWINGS

FIG. 1 is a drawing schematically illustrating the problems to be solved by the present invention;

FIG. 2 is a drawing schematically illustrating an example of channel in a microchip to be used in the present invention;

FIG. 3 is a drawing schematically illustrating an example of lid-sealed microchip constitution for use in the present invention;

FIG. 4 is a drawing schematically illustrating another example of lid-sealed microchip constitution for use in the present invention;

FIG. 5 is a drawing schematically illustrating an example of constitution of a peeling system for the lid seal part usable in the automatic sample processing apparatus according to the present invention, and illustrating the working principle utilized in the peeling system in a first exemplary embodiment;

FIG. 6 is a drawing schematically illustrating an example of constitution of a peeling system for the lid seal part usable in the automatic sample processing apparatus according to the present invention, and illustrating the working principle utilized in the peeling system in a second exemplary embodiment;

FIG. 7 is a drawing schematically illustrating an example of constitution of a peeling system for the lid seal part usable in the automatic sample processing apparatus according to the present invention, and illustrating the working principle utilized in the peeling system in a third exemplary embodiment;

FIG. 8 is a drawing schematically illustrating an example of constitution of a peeling system for the lid seal part usable in the automatic sample processing apparatus according to the present invention, and illustrating the working principle utilized in the peeling system in a fourth exemplary embodiment;

FIG. 9 is a drawing schematically illustrating an example of constitution of a peeling system for the lid seal part usable in the automatic sample processing apparatus according to the present invention, and illustrating the working principle utilized in the peeling system in a fifth exemplary embodiment;

FIG. 10 is a drawing schematically illustrating an example of constitution of a peeling system for the lid seal part usable in the automatic sample processing apparatus according to the present invention, and illustrating the working principle utilized in the peeling system in a sixth exemplary embodiment;

FIG. 11 is a drawing schematically illustrating an example of constitution of a peeling system for the lid seal part usable in the automatic sample processing apparatus according to the present invention, and illustrating the working principle utilized in the peeling system in a seventh exemplary embodiment; and

FIG. 12 is a drawing schematically illustrating another example of channel in the microchip to be used in the present invention. The following symbols used in the drawings have means respectively stated below.

101 Planar lid base part
102 Adhesive resin film layer
103 Substrate part
105a, 105b, 105c, 105d Liquid reservoir
107a Injection channel
107b Separating channel
110 Electrode terminal fixing member
112 Lid-sealed microchip
113 Lid seal part

### BEST MODES FOR CARRYING OUT THE INVENTION

The present invention will be explained in more detail below.

The sample to be processed in the automatic sample processing method according to the present invention is an electrophoresized fluid sample, which is prepared by subjecting a liquid sample for bioanalysis to a desired electrophoretic operation by utilizing a channel formed in a lid-sealed microchip, and thereby a plurality of substances contained in the liquid sample are positionally separated from each other so as to form the spots located along the channel. The electrophoretically separated fluid sample is held in a liquid state in the channel formed in the lid-sealed microchip at the time a predetermined electrophoretic separation has ended. When the electrophoretically separated fluid sample is to be used as the sample in a subsequent bioanalysis, it has to be subjected to sample preparation processing according to the bioanalytical technique to be applied subsequently.

For instance, in the case where the subsequent bioanalytical technique is mass analysis, it is necessary to once subject the substances, which are positionally separated to form spots along the channel, to the treatment for drying up to remove the solvent content therefrom. In that process, it is necessary to conduct the treatment for drying up by using a method which may prevent each of the substances, which are positionally separated to form spots along the channel, from mixing with one another. The automatic sample processing method and automatic sample processing apparatus according to the present invention are used for the form of processing, in which process the operation to take the electrophoretically separated fluid samples in the channel formed in the lid-sealed microchip out of this channel is omitted, and thus the solvent content contained therein is removed by evaporating in a state in which the samples are kept at the spots in the channel.

(Electrophoretically separated liquid sample to be processed)

First the electrophoretically separated fluid sample which is a target to be processed by the automatic sample processing method and automatic sample processing apparatus according to the present invention will be described below.

In the case where the channel formed in the lid-sealed microchip is to be utilized, electrophoretic separation equivalent to conventional capillary electrophoresis can be applied. Specifically, in the case where the biomolecules to be bioanalyzed, which are contained in the liquid sample, are proteins, isoelectric focusing, which separates different proteins by utilizing the difference in isoelectric points indicated by each protein, or phoretic separation, which separates them from one another by utilizing differences in phoretic velocity deriving from differences in molecular weight, can be used. In the case where the biomolecules to be bioanalyzed, which are contained in the liquid sample, are nucleic acid molecules, phoretic separation, which separates different nucleic acid molecules by utilizing differences in length of the base, namely differences in phoretic velocity deriving from differences in molecular weight, can be used.

In such cases, the planar shape of the channel itself formed in the lid-sealed microchip, the arrangement of the channel and the length of the channel are appropriately selected according to the method of electrophoretic separation used. For instance, the channel constitution having the planar shape shown in FIG. 2 can be selected. In the channel constitution shown in FIG. 2, a separating channel 107b for use in separation by isoelectric focusing and an injection channel 107a for introducing biomolecules to be focused on, for instance proteins, to the channel 107b are equipped on the top face of a substrate part 103. At the two ends of the separating channel 107b, liquid reservoirs 105d and 105c are formed, and acid and basic liquids for providing a pH gradient are introduced into the liquid reservoirs 105d and 105c, into which the terminals of electrodes for applying electric field therebetween are inserted. Liquid reservoirs 105a and 105b are also formed at the two ends of the injection channel 107a. Electrodes for applying electric field are also inserted into the liquid reservoirs 105a and 105b to generate electric field for use in the migration of proteins in the injection channel 107a.

In the case where the electrophoretic separation utilized is isoelectric focusing, it is also possible to select a channel constitution in which the injection channel 107a in the channel constitution shown in FIG. 2 is omitted, and only the separating channel 107b for use in separation by isoelectric focusing is provided. FIG. 12 shows an example of channel constitution provided only with the separating channel 107b for use in separation by isoelectric focusing. The liquid reservoirs 105d arid 105c are formed at the two ends of the separating channel 107b built in the top face of the substrate part 103, and acid and basic liquids for generating a pH gradient are introduced into these liquid reservoirs 105d and 105c. Electrode terminals for applying electric field are inserted to generate electric field for use in the migration of proteins in the separating channel 107b. Incidentally, though the shape of the separating channel 107b shown in FIG. 12 is a single-lane constitution, it can be expanded into a multi-lane type microchip in which a plurality of groove-shaped channels are provided in the top face of the substrate part 103.

(Structure of lid-sealed microchip and electrophoretic operation using it)

The lid-sealed microchip is composed of the substrate part 103 in whose top face a groove-shaped channel having a desired planar shape is formed and a lid seal part 113 with which the top face of that groove-shaped channel is tightly covered by sealing. Incidentally, holes for liquid injection are formed in the lid seal part 113, respectively matching the liquid reservoirs provided at the ends of the groove-shaped channel, while the top face of the groove-shaped channel is completely covered therewith. The lid seal part 113 is composed of a planar lid base part 101 having a function to hold the mechanical strength of the lid seal part 113 and, on its bottom face part, an adhesive resin film layer 102 to be used for adhesion to the top face of the substrate part 103. The holes for liquid injection built in the planar lid base part 101 and the adhesive resin film layer 102 are aligned with the liquid reservoirs 105d and 105c and the liquid reservoirs 105a and 105b. Furthermore, the holes for liquid injection built in the planar lid base part 101 and the adhesive resin film layer 102 are also utilized when the electrode terminals for applying electric fields are inserted into the liquid reservoirs 105d and 105c and the liquid reservoirs 105a and 105b. Incidentally in some cases, it is also possible to make up the planar lid base part 101 and the adhesive resin film layer 102 used for adhering its bottom face to the top face of the substrate part 103 of the same material. When the same material is used for the two elements, they can be produced in an integrated form in advance.

In order to attach and fix the electrode terminals for applying electric fields into the holes for liquid injection in the planar lid base part 101, an electrode terminal fixing member 110 is equipped to the planar lid base part 101 in advance. Prior to the electrophoretic operation, the electrode terminals for applying electric fields can be fixed by utilizing the electrode terminal fixing member 110, and at the stage of transferring from the end of the electrophoretic operation to the automatic sample process, the electrode terminals for applying electric fields are detached from the electrode terminal fixing member 110. Such lid base part 101 and electrode terminal fixing member 110 can either be made of different materials and assembled or made of the same materials, and in the latter case, they may be produced in an integrated form in advance. These attaching and detaching operations of the electrode terminals for applying electric fields accompanying the electrophoretic operation can be accomplished, after arranging and fixing the lid-sealed microchip in a predetermined position with the microchip fixing system of the electrophoretic apparatus, by using an electrode terminal attaching/detaching system for which the mutual positions of the plurality of electrode terminals for applying electric fields to be used have been determined in advance. Of course it is also possible to attach and detach the electrode terminals and fix the lid-sealed microchip by manual operation, but it is possible to make the microchip fixing system and the electrode terminal attaching/detaching system, which the electrophoretic apparatus is provided with, be constituted in an automatically operable form. Since it is desirable in particular in this invention, after completion of the electrophoretic operation, to automatically carry out a series of sample processing operations with the microchip itself held in its position, it is preferable to have a form of automating the operations of attachment and detachment of the electrode terminals and the operation to fix the lid-sealed microchip.

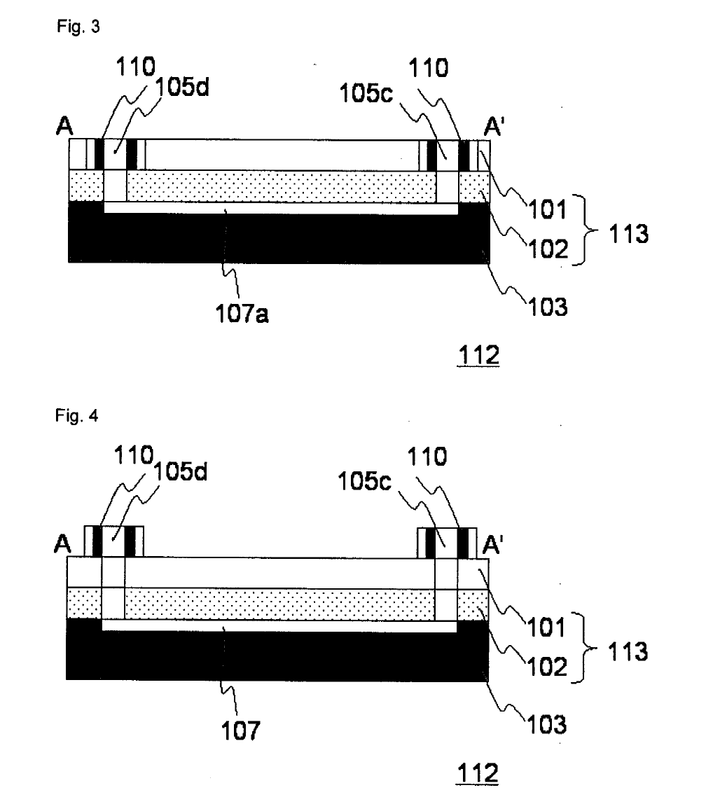

Incidentally, in the exemplary constitution shown in FIG. 3, the electrode terminal fixing member 110 is equipped and fixed in a form of constituting also the side wall part of the holes for liquid injection built in the planar lid base part 101, and it is also possible to select a structure in which the electrode terminal fixing member 110 is equipped and fixed in a form of coupling to the upper ends of the holes for liquid injection built in the planar lid base part 101 as in another constitution shown in FIG. 4.

The substrate part 103 and the lid seal part 113 are aligned with each other in terms of the positions of their respective holes for liquid injection and liquid reservoirs to constitute a structure in which the top face of the groove-shaped channel 107a is tightly covered by sealing with the lid seal part 113 by means of sticking the top face of the substrate part 103 and the bottom face of the lid seal part 113, namely the adhesive resin film layer 102, to each other. For bonding the planar lid base part 101 and the adhesive resin film layer 102, bonding means manifesting high bonding performance is employed; and when the lid seal part 113 is to be peeled and removed at the latter step, such a form that its peeling occurs on the adhesive plane between the top face of the substrate part 103 and the adhesive resin film layer 102 is selected. Thus, the adhesive plane between the top face of the substrate part 103 and the adhesive resin film layer 102 will exhibit a sufficient adhesive strength to achieve a closely enough adhered state to be free from such a fault that the phoretic liquid filled in the channel might leak or soak out from the groove-shaped channel 107a formed in the top face of the substrate part 103, but peeling will be enabled to take place along this adhesive plane by applying a predetermined external force.

When applying the automatic sample processing method and automatic sample processing apparatus according to the present invention, it is preferable to keep the closely adhered state between the top face of the substrate part 103 and the adhesive resin film layer 102 with the high adhesive strength of the adhesive resin film layer 102 itself. However, it is also possible to keep the closely adhered state between the top face of the substrate part 103 and the adhesive resin film layer 102 in a mode in which the adhesive strength of the adhesive resin film layer 102 itself is reduced and this lower strength is compensated for by imposing the load of an external force to keep the substrate part 103 and the lid seal part 113 in close adhesion. As means for imposing the external force to keep the substrate part 103 and the lid seal part 113 in close adhesion, a form of imposing a load over the top face of the lid seal part 113, that is, a load imposing system can be utilized. It is desirable to select for this load imposing system a mode in which the load can be dispersed substantially uniformly over the whole adhesive plane between the substrate part 103 and the lid seal part 113. Incidentally, it is preferable for the operation to peel and remove the lid seal part 113 to constitute a mode capable of operation automatically, similarly to the microchip fixing system and the electrode terminal attaching/detaching system, to remove the imposed load. For instance, the load imposing system and the electrode terminal attaching/detaching system can be integrated and, after the load has been applied by the load imposing system, electrode terminals are equipped by the electrode terminal attaching/detaching system.

As for the top face of the substrate part 103, such a material is to be selected which material permits achievement of the intended processing precision when the aforementioned processing of the fine structure is carried out to fabricate the fine groove-shaped channels 107 therein. According to the method of electrophoresis to be used, the sectional shape of the groove-shaped channels to be formed is selected in the channel width (W₁) and channel depth (D₁) range of 5 μm to 1000 μm. The fine groove-shaped channels of this “microchip” are mainly used for the operation of electrophoretic separation using an infinitesimal quantity of liquid sample, in place of capillary electrophoresis. Therefore, it is desirable to select the sectional area (D₁×W₁) of the fine groove-shaped channels to be as small as the inner sectional area of the capillary tube, for instance in a range of not exceeding the sectional area of the inner diameter of 100 μm. On the other hand, the ratio (D₁/W₁) of channel depth (D₁)/channel width (W₁) is appropriately selected, with the material of the substrate part 103 and the processing precision determined by the means for fine processing of the groove-shaped channels also being taken account. Generally, since an excessively high ratio (D₁/W₁) would increase the difficulty of processing, it is desirable to select the ratio in a range of 1/100≦D₁/W₁≦10.

Further when the automatic sample processing method and automatic sample processing apparatus according to the present invention are applied, the electrophoretically separated sample is subjected to the treatment for fixing in these fine groove-shaped channels by lyophilization to fix it as freeze-dried matters on the pertinent spots, and then the ingredient substances separated thereon are used for MALDI-MS analysis. In the steps, since it uses such a mode in which an ion species is generated from the freeze-dried matters present on the bottom faces of the groove-shaped channels and the generated ion species are taken out of the opening in the top face of the groove-shaped channels, it is desirable to make the selection generally in the range of D₁/W₁≦1.

When the automatic sample processing method and automatic sample processing apparatus according to the present invention are applied, since a state in which the electrophoretically separated sample remains with the frozen state being kept, the sectional shape of the groove-shaped channels can as well be rectangular, or can be a trapezoid shape as well in which the width of the top open parts (W_{1 top}) is narrower than the width of the bottom faces (W_{1 bottom}) of the grooves (W_{1 bottom}>W_{1 top}), which makes it difficult for the sample in the frozen state to come off.

As the material of the substrate part 103, a material suitable for fine processing, such as quartz, glass or silicon, is suitably used. Further, what can achieve the intended precision of fine processing out of highly insulative plastics including polycarbonates, PDMS and PMMA can be used as well. As the electric fields are applied into the groove-shaped channels to be formed in its top face, the substrate part 103 itself needs to be insulated from the phoretic liquid in the groove-shaped channels, and accordingly the use of a highly insulative material, such as quartz or glass, is desirable. In the case where a material inferior in insulative performance, such as silicon, is used, a constitution in which an insulative coating layer is provided over the inner walls of the groove-shaped channels is used to attain the intended electrical insulation from the phoretic liquid in the groove-shaped channels. Alternatively, it is also possible to employ such a mode in which the groove-shaped channel part is formed by utilizing a silicon oxide layer formed over a silicon substrate.

Further, in the present invention, at the step of carrying out peeling, the substrate part 103 is not elastically deformed but the lid seal part 113 is elastically deformed, and thereby a flexible structure is provided on the boundary part of peeling. Therefore, a material exhibiting flexibility is used for the planar lid base part 101. Or the lid seal part 113 may have an enough thickness to allow the lid seal part 113 to be elastically deformed.

In the present invention, such a material that is capable of being subjected to processing, such as building the holes for liquid injection therein, is excellent in insulating performance, and also has flexibility is suitably used for the material for the planar lid base part 101. For instance, one of acryl resins such as PMMA (polymethyl methacrylate) or of polymeric resin materials including PDMS (polydimethyl siloxane), especially a flat material that will be easily processed but is not susceptible to fracture even if the thickness is thin, is preferably used. For the material used for the base of the adhesive resin film layer 102, for instance, PDMS, one of polyorefines including PTFE (polytetrafluoroethylene), PP (polypropylene), PE (polyethylene) and polyvinyl chloride, or a polyester is used. For the adhesive resin film layer 102, it is preferable to use a material higher in elastic deformability than the material for the planar lid base part 101. A form in which a coat of an adhesive which gives adhesiveness is provided on the outermost layer of the adhesive resin film layer 102 is desirable. Incidentally, the area of the top face of the groove-shaped channels corresponding to the layer has no coat of the adhesive, but may preferably be a surface exhibiting hydrophobicity and water repellency. Therefore, for the base of the adhesive resin film layer 102, a material having water repellency and oil repellency such as a fluorine resin such as PTFE can be suitably used.

In the lid-sealed microchip itself, the external shape of the substrate part 103 is rectangular, and the external shape of the lid seal part 113 which seals its top face also is rectangular. When to peel and remove the lid seal part 113, in order to apply an external force to one end of the lid seal part 113, a part protruding from the external shape of the substrate part 103 may be provided at least toward the end used for the application of the external force. For instance, in the case where the direction of peeling and removing the lid seal part 113 is selected along the longer side of the rectangle of the external shape of the substrate part 103, the external shape of the lid seal part 113 is made greater in this longer side than the longer sides of the substrate part 103. When an external force is applied to the lid seal part 113, it is made possible to set its working point at the part protruding in the longer side thereof. Furthermore, after completion of the peeling and removing of the lid seal part 113, it is made possible to set in said protruding part an area for supporting the ends of the separated lid seal part by a holding system when the operation for detaching is carried out by holding and transferring the separated lid seal part away from the top face of the substrate part. Further, it is also possible to choose a mode in which a part protruding in the shorter side direction of the lid seal part 113 along the longer side of the substrate part 103 is used as a site to apply the external force when peeling and removing the lid seal part 113.

(System for injecting electrophoretic liquid into channels built in lid-sealed microchip)

As mentioned above, for the channel built in the lid-sealed microchip, its sectional area (D₁/W₁) is supposed to be as small as that of a capillary, but there are not rare cases that the material of the lid seal part 113 constituting its top face is poor in water wettability. A capillary made of a material of high water wettability allows the electrophoretic liquid to be supplied from one end of the channel to all over the capillary through the capillary phenomenon, but for the channels in the microchip having internal wall faces poor in water-wettability, it is necessary to provide a liquid injecting system, in place of electrophoretic liquid injection utilizing the capillary phenomenon. Specifically, it is preferable to use such a mode in which a pressure difference is created between liquid reservoirs provided at the ends of channels and the insides of the channels, and the resulted pressure difference is utilized for forcibly injecting the electrophoretic liquid supplied from one liquid reservoir into the channels.

As the channels themselves formed in the lid-sealed microchip are tightly covered by sealing, when gas being left inside is pulled out through one liquid reservoir and the electrophoretic liquid is supplied to the other liquid reservoir, the electrophoretic liquid infiltrates into the channels due to the pressure difference between them. In that step, injection is stopped when the electrophoretic liquid has wholly filled the channels. In the case where the electrophoretic liquid injection technique utilizing the pressure difference is used, the operation for the electrophoretic liquid injecting can be automated by using such a constitution in which an aspirating system for pulling out gas being left inside is attached to one of the liquid reservoirs; a liquid feeding system with micro-liquid measure fit for injecting a predetermined quantity of the electrophoretic liquid is coupled to the other liquid reservoir; and further, the two systems are linked with a judgment system which automatically determines the end timing of its injection action.

As the judgment system which automatically determines the end timing of the injection action, for instance, a judgment system which utilizes such a detection unit as exemplified below to detect whether or not the injected electrophoretic liquid has wholly filled the channels can be used.

When the electrophoretic liquid has wholly filled the channels, as the electrophoretic liquid itself is a medium having some electroconductivity, a rapid change from an insulating state to a predetermined resistance can be observed by monitoring the resistance value between the two ends of each channel. By equipping such a resistance monitoring type detection unit at each end of each channel, in which the function of the electrophoretic liquid as an electroconductive medium is utilized, it is made possible to judge on the filled state of the electrophoretic liquid.

Further, the electrophoretic liquid is a liquid, and its dielectric constant differs markedly from that of a gas. By utilizing this feature, it is possible to use such a monitoring unit in which two electrodes of planar capacitor type are provided on the two side walls of each channel to detect the phenomenon that when the electrophoretic liquid infiltrates into the space between the electrodes, it brings on a change in capacitance. By equipping such a detection unit of planar capacitor type at each end of each channel, it is made possible to judge on the filled state of the electrophoretic liquid.

Furthermore, as the electrophoretic liquid is a liquid, it differs significantly from a gas in refractive index as in dielectric constant. For instance, in the case where the substrate part 103 is made of a light-transmissive material, the light reflectance at the wall faces of the channels formed in its top face changes when the electrophoretic liquid comes to cover the wall faces. When providing with such a reflectance detecting unit in which light reflectance from one wall face of a channel is detected by using the phenomenon, it is also made possible to decide whether or not the electrophoretic liquid has reached a part of the monitored wall face of the channel. By equipping each end of each channel with the liquid detecting unit of the wall face light reflectance monitoring type, it is made possible to judge the filled state of the electrophoretic liquid.

Automation of the whole electrophoretic liquid injecting operation can be achieved by integrating the system for judging the filled state of the electrophoretic liquid with use of the aforementioned liquid detecting units and the electrophoretic liquid injecting system utilizing the pressure difference and thereby automatically deciding the end timing of the injection operation.

(System for fixing substrate part of lid-sealed microchip, substrate part cooling system and control unit for cooling system)

When the lid seal part 113 is peeled and removed from the top face of the substrate part 103 of the microchip, after fixing the substrate part 103, the external force is applied to one end of the lid seal part 113 to forcibly displace the one end of the lid seal part 113 in a substantially perpendicular direction to the adhesive plane between the substrate part 103 and the lid seal part 113. Accompanying this displacement of its one end, the lid seal part 113 is given a flexible structure relative to the adhesive plane.

At the stage where the external force has been applied, the substrate part is fixed to prevent the substrate part 103 from moving. At the same time, prior to the operation to peel and remove the lid seal part 113, the electrophoretically separated liquid sample present in the groove-shaped channels of the substrate part 103 is cooled to place the whole liquid sample in a frozen state. This liquid sample is in a state in which soluble substances electrophoretically separated into the electrophoretic liquid are dissolved, forming spots. Although its solvent content is water, buffer contents and the like are dissolved therein, and thus because of the freezing point depression, its freezing starts at a temperature below the ice point (0° C.). For this reason, it is desirable to rapidly refrigerate the whole liquid sample down to a temperature significantly lower than the temperature at which freezing starts to once place it in a supercooled state, whereby the whole liquid sample in the groove-shaped channels freezes in an instant. On the other hand, if the solvent water is slowly frozen at a temperature slightly lower than the temperature at which freezing starts, freezing will start elsewhere than spots because, though the concentrations of dissolved substances are higher at spots, the concentrations of substances are low in other areas than the spots. In such a case, the volume expansion resulting from the freezing compresses the unfrozen areas around the spots, and it could cause leaking of the liquid out of the groove-shaped channels. In order to avoid such a situation, it is desirable to achieve a state in which freezing progress over the whole insides of the groove-shaped channels by rapidly refrigerating the liquid sample to a temperature significantly lower than the temperature at which freezing starts to once place it in a supercooled state.

Accordingly, it is preferable to utilize the substrate part cooling system which once achieves a supercooled state by rapidly cooling the liquid from the bottom face of the substrate part 103 of the microchip to bring the whole channel to a uniform temperature, which is significantly lower than the temperature at which freezing starts. Desirably, the refrigerating system may have an arrangement in which it is in uniform contact with the whole bottom of the substrate part, and a form in which the substrate part fixing system and the substrate part refrigerating system are integrated is desirable.

For the fixing of the substrate part, though a style in which the side wall parts of the substrate part are fixed is available, such a style of fixing the bottom face of the substrate part is preferable. For instance, such a style in which, after the bottom face of the substrate part is machined into a flat plane, the bottom face of the substrate part is fixed in a predetermined position on a fixed stage of a vacuum chuck system is suitably used. Although the thickness itself is a few mm or less, since the planar size of the substrate part 103 of the microchip is not as small as a few mm, but its short and long sides are well over 10 cm though not much larger than that, and therefore it is preferable to use a mode in which the face of the fixed stage of a vacuum chuck system is refrigerated to a predetermined temperature by utilizing refrigerating means such as a Peltier device.

Incidentally, in said substrate part fixing system being integrated with the substrate part refrigerating system, as the fixed stage face and the lid-sealed microchip are refrigerated to a temperature significantly lower than the ice point (0° C.), if the ambient atmosphere contains moisture, it will be condensed and become frozen. To prevent the condensation and freezing, the ambient atmosphere of the fixed stage face and the lid-sealed microchip are so constituted as to be kept in a dry gaseous atmosphere containing no moisture. Specifically, it will have such a constitution that the area itself containing the substrate part fixing system and the substrate part refrigerating system is installed in an airtight sealed vessel, and the interior of this airtight sealed vessel is maintained as a dry air or dry nitrogen atmosphere.

In a state in which the liquid sample in the channels is not frozen, as the vibration could constitute a factor to cause liquid mixing in the channels during transportation, the substrate part 103 of the microchip is fixed, in the step of operating the above-described electrophoretic separation, to such integrated substrate part fixing system and substrate part refrigerating system in the position where the microchip is fixed. The substrate part fixing system and substrate part refrigerating system being integrated are provided for the electrophoretic apparatus and, at the time the operations for the electrophoretic separation has ended, the fixation of the substrate part 103 of the microchip and rapid refrigeration of the substrate part are promptly executed by the substrate part fixing system and substrate part refrigerating system being integrated.

At the stage of the operation for electrophoretic separation, if some other fixing means is used for the fixation of the substrate part 103 of the microchip, a mode of transferring the integrated substrate part fixing system and substrate part refrigerating system to a position where close contact with the bottom of the substrate part 103 of the microchip can be accomplished is utilized. Alternatively, when the lid-sealed microchip is set and fixed in a predetermined position on the apparatus prior to the electrophoretic separation, even in such a case where such a substrate part fixing system and substrate part refrigerating system being integrated are used to fix, it is also possible to choose a mode in which the substrate part fixing system and substrate part refrigerating system being integrated can be transferred accompanying the operation for carrying-in of the lid-sealed microchip to be used.

In order to rapidly refrigerate the whole liquid sample down to a temperature significantly lower than the temperature at which freezing starts to once place it in a supercooled state, whereby the whole liquid sample in the groove-shaped channels freezes in an instant, it is desirable to set the refrigerating temperature to a range at least 10° C. to 30° C. lower than the ice point (0° C.), at least −20° C. or below. When refrigerated to said refrigerating temperature, the liquid sample is once placed in a supercooled state, and thereby the whole liquid sample in the groove-shaped channels proceeds to freezing in an instant.

The series of operations comprising the fixation of the substrate part 103 of the microchip by the substrate part fixing system, freezing of the liquid sample in the groove-shaped channels via the refrigeration of the substrate part 103 by the substrate part refrigerating system and subsequent temperature control to maintain the frozen state can be automated by the control unit of the refrigerating system and accomplished under predetermined conditions.

(System for peeling and removing lid seal part)

In the present invention, when the substrate part 103 and the lid seal part 113 composing lid-sealed microchip are to be separated, a technique to peel and remove, after fixing the substrate part 103 of the microchip, the lid seal part 113 tightly stuck to the top face of the substrate part 103 is employed.

Specifically, in order to release the adhesive strength achieving a state of adhesion in a predetermined arrangement in which the top face of the substrate part 103 and the bottom face of the lid seal part 113 tightly stuck to each other, an external force having a component in a substantially perpendicular direction to the top face of the substrate part 103 is applied to an end of the lid seal part 113 to bend the lid seal part 113, and peeling is proceeded at a desired velocity in a form of lifting upward the end of the lid seal part 113 while keeping the bend at a predetermined curvature. In the present invention, at the step of peeling the lid seal part 113, peeling also proceeds quickly on the top face of the electrophoretically separated sample in the groove-shaped channels being kept in the frozen state, which is in contact with the bottom face of the lid seal part 113, and thus the peeling of the lid seal part 113 is completed in a state in which the frozen electrophoretically separated sample is left in the groove-shaped channels.

When applying the automatic sample processing method and automatic sample processing apparatus according to the present invention, keeping the state of close adhesion between the top face of the substrate part 103 and the bottom face of the lid seal part 113 relies on the adhesive strength itself of the bottom face of the lid seal part 113 to the top face of the substrate part 103. On the other hand, even in a refrigerated state, the adhesive strength p₁ per unit area between the bottom face of the lid seal part 113 and the top face of the frozen electrophoretically separated sample is set smaller than the adhesive strength p₀ per unit area between the top face of the substrate part 103 and the bottom face of the lid seal part 113 (p₀>p₁).

In this process, because of the adhesive strength between the top face of the substrate part 103 and the bottom face of the lid seal part 113, there is a range in which peeling does not begin even when one end of the lid seal part 113 is lifted in a direction substantially perpendicular to the top face of the substrate part 103 and the lid seal part 113 is bent. In a state in which an even greater bend is observed, there is a threshold at which peeling begins. The bent shape, at the time in which the threshold condition is satisfied, is defined by δ which is the quantity of displacement from the top face of the substrate part 103 at one end of the lid seal part 113 and L which is the length from the boundary where the top face of the substrate part 103 and the bottom face of the lid seal part 113 come into contact with each other to the working point of the external force imposed on the one end of the lid seal part 113, and manifests an arciform shape having a substantially constant radius of curvature R. Thus, with the angle of this arc being represented by θ, the following equations are satisfied.

L=R·θ

δ=R(1−cos θ)

When the bend is in this shape, the force P applied to the boundary where the top face of the substrate part 103 and the bottom face of the lid seal part 113 come into contact with each other is approximately expressed as follows wherein d is the thickness, b is the breadth and E is the effective Young's modulus of the lid seal part 113:

δ=P·(2L)³/{4bd³E}

P=δ·(4bd³E)/(2L)³

When the displacement quantity δ of one end of the lid seal part 113 is increased as δ→δ+Δδ, the radius of curvature R representing the bent shape varies as R→R−ΔR₁, and its arciform angle θ becomes θ→θ+Δθ₁, the transitional variation is described as follows:

$$L = ( R - Δ {R}_{1} ) \cdot ( θ + {Δθ}_{1} ) \approx R \cdot θ + \{ R \cdot {Δθ}_{1} - Δ {R}_{1} \cdot θ \}$$

$$δ + Δδ = ( R - Δ {R}_{1} ) \cdot \{ 1 - cos ( θ + {Δθ}_{1} ) \} \approx ( R - Δ {R}_{1} ) \cdot ( 1 - cos θ + {Δθ}_{1} \cdot sin θ ) \approx R ( 1 - cos θ ) + \{ R \cdot {Δθ}_{1} \cdot sin θ - Δ {R}_{1} \cdot ( 1 - cos θ ) \} \approx R ( 1 - cos θ ) + Δ {R}_{1} \cdot \{ θ \cdot sin θ - ( 1 - cos θ ) \}$$

When the bend is in this shape, the force P+ΔP₁ applied to the boundary where the top face of the substrate part 103 and the bottom face of the lid seal part 113 come into contact with each other is approximately expressed as follows.

P+ΔP₁=(δ+Δδ)·(4bd³E)/(2L)³

The peeling slightly proceeds as such decrease P+ΔP₁→P is attained. And thus, it returns to a state in which the peeling no longer proceeds. At the time of that peeling stop, the bent shape manifests an arciform shape having a substantially constant radius of curvature R.

$$L + Δ L = R \cdot ( θ + {Δθ}_{2} )$$

$$δ + Δ δ = R \cdot \{ 1 - cos ( θ + Δ {θ}_{2} ) \} \approx R \cdot ( 1 - cos θ + {Δθ}_{2} \cdot sin θ ) \approx R \cdot ( - cos θ ) + R \cdot Δ {θ}_{2} \cdot sin θ$$

At this stage, the force P−ΔP₂ applied to the boundary where the top face of the substrate part 103 and the bottom face of the lid seal part 113 come into contact with each other is approximately expressed as follows.

$$P - Δ {P}_{2} = ( δ + Δδ ) \cdot \frac{\{ 4 {bd}^{3} E \}}{{\{ 2 ( L + Δ L ) \}}^{3}} \approx ( δ + Δδ ) \cdot \frac{\{ 4 {bd}^{3} E \}}{\{ {( 2 L )}^{3} \cdot ( 1 + 3 Δ L / L ) \}} \approx ( δ + Δδ ) \cdot ( 1 - 3 Δ L / L \cdot \{ 4 {bd}^{3} E \} / {( 2 L )}^{3}$$

Thus, when the decrease: (P+ΔP₁)→(P−ΔP₂) are taken place, the ΔL part is peeled off. Therefore, the decrease in adhesive strength of the ΔL part corresponds to the change: (P+ΔP₁)→(P−ΔP₂). The adhesive strength p₀ per unit area between the top face of the substrate part 103 and the bottom face of the lid seal part 113 being represented by p₀:

$$( Δ {P}_{1} + Δ {P}_{2} ) = ( 3 Δ L / L ) \cdot ( δ + Δδ ) \cdot ( 4 {bd}^{3} E ) / {( 2 L )}^{3} \approx {p}_{0} \cdot b \cdot Δ L$$

In other words, when the peeling proceeds, it is estimated that a distortion (a small bend whose radius of curvature R is small) surpassing a threshold condition represented by:

3·(1/L)·P≈p₀·b>p₁·b

needs to be maintained on the boundary where the top face of the substrate part 103 and the bottom face of the lid seal part 113 come into contact with each other.

Thus, the external force imposed on the end of the lid seal part 113 is 1/2P, and is selected in a range where

(1/2P)>p₀·b·L/6

is maintained, which causes the peeling to proceed. Of course, in such a case, also the peeling between the top face of the frozen electrophoretically separated sample and the bottom face of the lid seal part 113 then proceeds at the same time.

This condition requires the peeling to be accomplished in a state where the radius of curvature R on the boundary where the top face of the substrate part 103 and the bottom face of the lid seal part 113 come into contact with each other, namely the boundary on which the peeling proceeds, is smaller than the radius of curvature R_{eq1} (R<R_{eq1}) under the foregoing threshold condition.

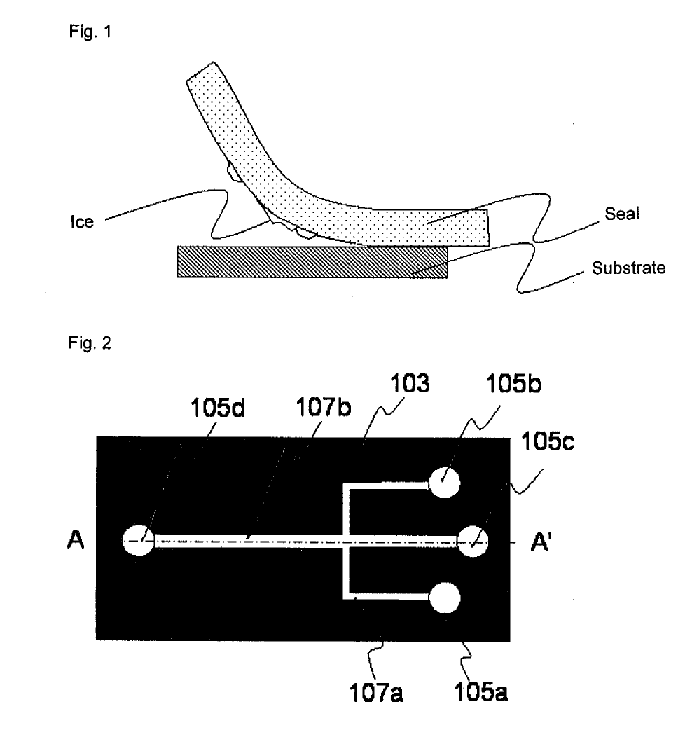

On the other hand, when the radius of curvature R representing the bend varies significantly, especially when the radius of curvature R once increases and then returns to the original small value, a large tensile stress suddenly works on the top face of the frozen electrophoretically separated sample, too. As a result, whereas many flaws (grain boundaries) are present in a frozen body, and flaking takes place from those flaws (grain boundaries) and the resulted flakes stick as they are to the bottom face of the lid seal part 113. By maintaining a state in which the radius of curvature R representing the bend does not vary, the trouble shown in FIG. 1, namely the phenomenon that flaking takes place from such flaws (grain boundaries) and the resulted flakes stick as they are to the bottom face of the lid seal part 113, can be avoided.

The external force imposing system provided with a function to impose the external force having a component of a direction substantially perpendicular to the top face of the substrate part on the end of the lid seal part, the lid seal part end transferring system which transfers the end of the lid seal part in a direction substantially perpendicular to the boundary of contact between the top face of the substrate part and the bottom face of the lid seal part in synchronism with the imposition of the external force on the end of the lid seal part, and a lid seal part end transfer speed control system provided with a function to so control the transfer speed of the end of the lid seal part as to maintain the radius of curvature R, which is manifested by the local bend of the lid seal part on the boundary where the peeling proceeds, at a predetermined target value, at the step of peeling the bottom face of the lid seal part off from the top face of the substrate part, are integrally constituted, and the constitutions described below, for example, can be selected therefor.

### FIRST EXEMPLARY EMBODIMENT

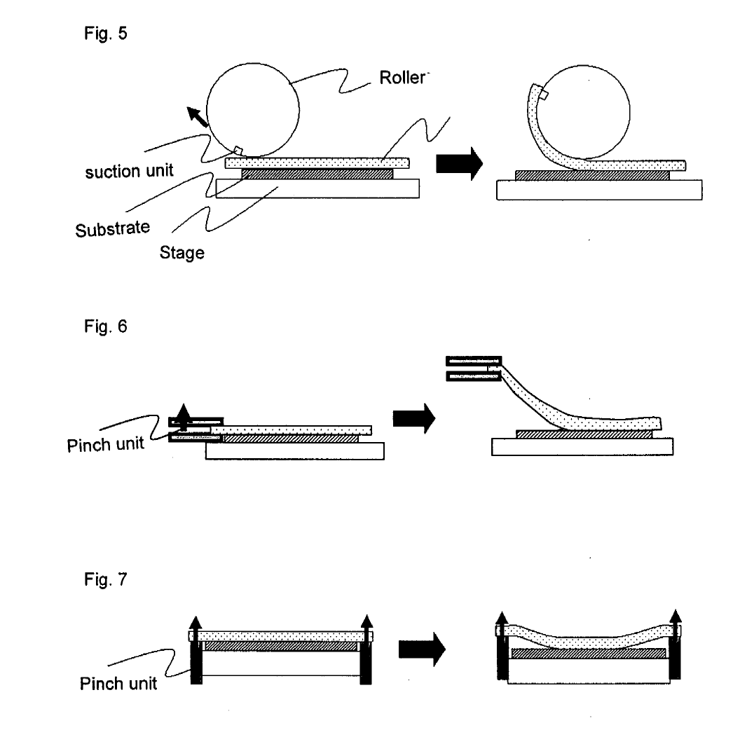

The peeling system for the lid seal part shown in FIG. 5 is of a type which, after vacuum-suction of an end of the lid seal part, winds it up by using a roller having a predetermined radius. The radius of curvature R representing the bend of the lid seal part becomes equal to the radius of the roller and, by keeping the winding speed constant, the transfer speed of the end of the lid seal part is also made constant.

According to the target value of the radius of curvature R representing the bend of the lid seal part, the radius of the roller is adjusted, and the winding speed is set.

### SECOND EXEMPLARY EMBODIMENT

The lid seal part peeling system shown in FIG. 6 is of a type which, after chucking an end of the lid seal part with a pinch, lifts it up. In this action, the lifting speed is selected according to the target of the radius of curvature R representing the bend of the lid seal part.

### THIRD EXEMPLARY EMBODIMENT

The lid seal part peeling system shown in FIG. 7 is of a type which lifts one end or both ends of the lid seal part. The pinch unit or units for moving the end or ends of the lid seal part thrust upward the bottom face of the lid seal part. In this action, the lifting speed is selected according to the target of the radius of curvature R representing the bend of the lid seal part.

### FOURTH EXEMPLARY EMBODIMENT

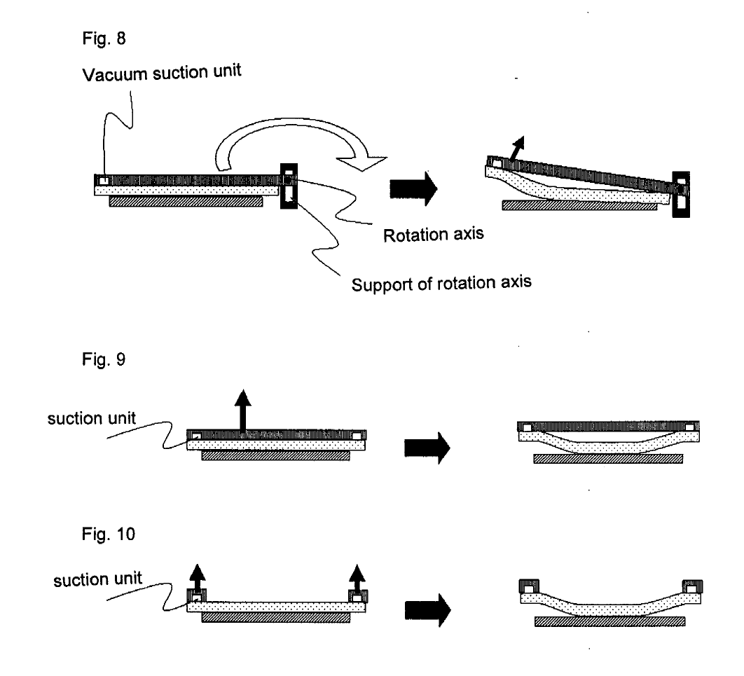

The lid seal part peeling system shown in FIG. 8 is of a type which, after an end of the lid seal part is chucked by a vacuum suction unit, lifts it. In this action, the lifting speed is selected according to the target of the radius of curvature R representing the bend of the lid seal part.

The control of the lifting speed is adjusted within a desired range by using the rotational angle of the lifting arm and the vertical moving speed of a stanchion supporting the rotation axis.

### FIFTH EXEMPLARY EMBODIMENT

The lid seal part peeling system shown in FIG. 9 is of a type which, after an end of the lid seal part is chucked by a vacuum suction unit, lifts it. In this action, the lifting speed is selected according to the target of the radius of curvature R representing the bend of the lid seal part.

In some cases, a stage fixing the substrate part may be lowered to lift the lid seal part in relative terms.

### SIXTH EXEMPLARY EMBODIMENT

The lid seal part peeling system shown in FIG. 10 also is of a type which, after an end of the lid seal part is chucked by a vacuum suction unit, lifts it. In this action, the lifting speed is selected according to the target of the radius of curvature R representing the bend of the lid seal part.

In some cases, a stage fixing the substrate part may be lowered to lift the lid seal part in relative terms.

### SEVENTH EXEMPLARY EMBODIMENT

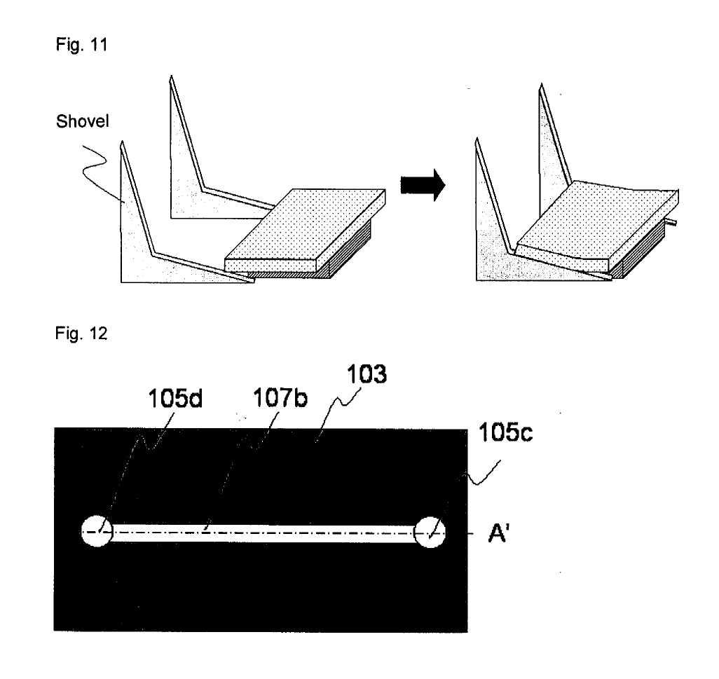

The lid seal part peeling system shown in FIG. 11 is of a type which, after a shovel-shaped guide unit having a predetermined slope angle is inserted from an end of the lid seal part, transfers the guide unit while lifting the end of the lid seal part along this slope. In this action, the radius of curvature R representing the bend of the lid seal part is controlled by selecting the transferring speed according to the target of the radius of curvature R.

Specifically, the radius of a circle inscribing the slope and the top face of the substrate part constitutes the radius of curvature R representing the bend of the lid seal part. The radius of curvature R representing the bend of the lid seal part shrinks with a rise in transferring speed. Where the transferring speed is fixed, adjustment is made to the radius of curvature R representing the bend determined by that condition.

(Detaching system for separated lid seal part)

In the present invention, peeling of the lid seal part 113 is completed in a state in which the frozen electrophoretically separated sample is left in the groove-shaped channel. After that, the separated lid seal part is held, for instance in the above-described second exemplary embodiment, in a state in which the end of the lid seal part is chucked by the pinch unit, and removed from the top face of the substrate part by transferring the pinch unit. Further, in the fourth exemplary embodiment through the seventh exemplary embodiment, it is removed from the top face of the substrate part by being transferred in a state of being held by the system used for peeling. In the third exemplary embodiment, such a mode in which the separated lid seal part is removed from the top face of the substrate part by separately transferring the pinch unit or units in a state in which its end or ends are held by the pinch unit or units can be employed.

Since the frozen electrophoretically separated sample is kept in a state of being left in the groove-shaped channel, it can also be carried to another apparatus as contained in the substrate part. The groove-shaped channel formed in the substrate part is in an exposed state, and the sample can be subjected to treatment for lyophilization as it is for instance.

(Analytical method for biosamples)

In the analytical method for biosamples according to the present invention, if isoelectric focusing is used as the operation for electrophoresis, information on the isoelectric points (pl), and the molecular weights (M) and the amount (C) based on MALDI-MS analysis becomes available regarding a plurality of types of proteins contained in the liquid sample to be bioanalyzed. By utilizing these two kinds of information (pl and M), it is possible to semi-quantitatively predict what “two-dimensional electrophoretic” patterns will be manifested when individual proteins are separated according to their apparent molecular weights and differences in isoelectric point (pl) by subjecting the plurality of types of proteins contained in the liquid sample to be bioanalyzed to so-called two-dimensional electrophoresis. Therefore, when “marker proteins” related to various diseases are to be searched for, by comparing samples collected from patients and samples collected from healthy persons and searching for “unidentified proteins” associated with the likely “marker proteins” for those diseases, the range of samples to be analyzed by “two-dimensional electrophoresis” can be narrowed down.

(Apparatus for microchip chemical analysis)

A preferable overall constitution of the apparatus for microchip chemical analysis according to the present invention will be further described.

The apparatus for microchip chemical analysis according to the present invention is applied to handle, in particular, electrophoretically separated fluid samples, in which, as object samples, liquid samples to be bioanalyzed is subjected to the operation for desired electrophoretic separation by utilizing the channel formed in the lid-sealed microchip, whereby each of a plurality of substances contained in the liquid samples is positionally separated to form a spot along the channel, but it may also be applied when some other chemical analytical technique than separation by electrophoresis is to be utilized.

In such a case, its overall hardware constitution is set up in such a constitution comprising a chemical analyzing unit 1 for chemically analyzing samples in the channel of the microchip, a solution fixing unit 2 for fixing chemically analyzed samples and electrophoretic liquids, and a lid seal part separating unit 3 for separating the lid seal part from the substrate part to expose fixed samples in the channel in the substrate part of the microchip. There is no limitation to other individual members or systems equipped accompanying a structure capable of chemically analyzing samples in the microchip or annexed systems to be employed for applying said samples to analyses at the next and subsequent stages as long as they do not affect analyses by the chemical analyzing unit 1.

Chemical analyses to be accomplished by the chemical analyzing unit in the present invention, though not limited in particular, include electrophoretic separation for instance, and isoelectric focusing which allows concentration of the sample at individual isoelectric points is particularly suitable. In this case, the chemical analyzing unit 1 may be composed of an electrode part and a phoretic power source. A voltage is supplied from the phoretic power source to the electrode part via wiring, and the voltage is applied to the electrophoretic liquid in the channel of the microchip by using the electrode part to causes electrophoresis to take place. It is also possible to further arrange a liquid reservoir lid unit over the lid seal part of the microchip to restrain evaporation of the electrophoretic liquid in the channel. Further, a current monitor for monitoring the current level during applying the voltage may also be provided.

The chemical analyzing unit 1 may further be provided with a transferring system for automatically transferring the liquid reservoir lid unit and/or the electrode part to their predetermined positions. One or a plurality of such accessory systems may be used either independently or in combination.

For the solution fixing unit 2 in the present invention, though there is no particular limitation, used is, for instance, a refrigerating system for fixing by freezing the sample or the electrophoretic liquid chemically analyzed by said chemical analyzing unit 1.

Desirably, the refrigerating system in the present invention may be of a type which refrigerates the substrate part of the microchip by coming into direct contact. There may be only one refrigerating system or a plurality of such systems, which may be supplemented on the system of the substrate part side with a secondary refrigerating system providing refrigeration from the lid seal part side via the liquid reservoir lid unit. Available ones include but are not limited to, for instance, a refrigerating system using a Peltier device or a chiller.

The lid seal part separator 3 used in the present invention has a system which attracts by vacuum-chucking, comes into contact with or fixes the lid seal part, a system which pneumatically attracts, comes into contact with or fixes the substrate part and a transferring system which brings the fixed lid seal part and the substrate part away from each other.

The system which attracts by vacuum-chucking, comes into contact with or fixes the lid seal part used in the present invention, though there is no particular limitation, may be a suction unit which causes the lid seal part to be attracted by vacuum-chucking to the fixing system, an agglutinant unit 12 which agglutinates the lid seal part to the fixing system, or a lid seal part fixing unit which brings the lid seal part into contact with or fixes it to the fixing system.

The system which attracts by vacuum-chucking, comes into contact with or fixes the substrate part used in the present invention, though there is no particular limitation, may be for instance a substrate part sucking unit which causes the substrate part to be attracted by vacuum-chucking to the fixing system, a substrate part agglutinating unit which agglutinates the substrate part to the fixing system, or a substrate part fixing unit which brings the substrate part into contact with or fixes it to the fixing system.

The lid seal part vacuum suction unit or the substrate part vacuum suction unit available for use in the present invention has a suction hole and a pressure reducing system which reduces the pressure through the suction hole, and can attract by vacuum-chucking an object approaching the suction hole.

The transferring system used in the present invention, which system brings the fixed lid seal part and the substrate part away from each other, though there is no particular limitation, may be for instance a chip stage unit which moves up and down the substrate part or the lid seal part, a roller which turns to wind up the lid seal part, a pinch unit or a hooking unit which pinches or hooks the lid seal part or the substrate part, or an opening/closing unit which opens or closes around the shaft as the center of rotation.

The apparatus for microchip chemical analysis of the present invention may further be provided with, as required, a lid seal part-substrate part joining system which constructs microchips by joining, a solution injecting system for injecting the sample and/or the electrophoretic liquid into the channel of the microchip, a drying-up system for drying, after detaching the lid seal part from the substrate part, the sample and/or the electrophoretic liquid exposed on the substrate part, and a signal detection unit for detecting the progress or results of chemical analysis.

The lid seal part-substrate part joining system used in the present invention, though there is no particular limitation, may be for instance a positioning guide such as a projection, dent, hole or pin designed to match the shape of microchips, a holder for holding a microchip, or a transferring system which joins the substrate part and the lid seal part by arranging them in predetermined positions and pressing the substrate part and the lid seal part to increase the tightness of adhesion. One or a plurality of such systems may be used either independently or in combination.

The solution injecting system used in the present invention, though there is no particular limitation, may be for instance a pressure reducing system or a pressure applying system which generates a pressure difference between openings positioned at the two ends of the microchip channel, which brings in solution.

The drying-up system used in the present invention, though there is no particular limitation, may be for instance a heating system for evaporating the frozen sample and/or electrophoretic liquid exposed on the substrate part, or a sealed vessel and pressure reducing system for sublimating the frozen sample and/or electrophoretic liquid exposed on the substrate part. By arranging the substrate part in the sealed vessel and reducing the pressure in the sealed vessel, the frozen sample and/or the electrophoretic liquid can be sublimated. However, since the frozen sample and/or the electrophoretic liquid exposed by the removal of lid seal part after the chemical analysis is dissolved and diffused in the liquid when the ambient temperature rises, it is possible to maintain the condition resulted from the analysis only in a refrigerated state. By drying them with the drying-up system, however, the sample and/or the electrophoretic liquid in the channel can be completely fixed irrespective of the ambient temperature.

The signal detection unit used in the present invention, though there is no particular limitation, may be provided, for instance, with a light-irradiating unit. The signal detection unit has at least a light detector for measuring optical wavelength signals such as absorption wavelengths or fluorescence. For instance, the channel is irradiated with an exciting light from the light-irradiating unit, and the fluorescence is detected by using the light detector. This signal detection unit may be used when analyzing a sample by using the chemical analyzing unit 1, after the fixation of the solution by using the solution fixing unit 2 post to the analysis, for monitoring upon the channel holding the exposed channel after separating the lid seal part by using the lid seal part separating unit 3, or upon the channel holding the sample dried and fixed by using the drying-up system.

The apparatus for microchip chemical analysis of the present invention may be constituted by employing one, a plurality of or in combination of the modes so far described.

It is preferable for the apparatus for microchip chemical analysis of the present invention to be further provided with a controlling unit with a view of easy operation. The controlling unit can be used for monitoring the current level by using a current monitoring unit to control the voltage supplied from the power source. Further, the controlling unit can be used for determining the end of chemical analysis based on the current level monitored, the duration of voltage application, and also for controlling the operation of the refrigerating system. Further, the controlling unit can also be used for controlling the operations of the system to attract by vacuum-chucking, bring into contact or fix the lid seal part, the system to attract by vacuum-chucking, bring into contact or fix the substrate part and the transferring system which parts fixed lid seal part and the substrate part away from each other, and thereby to expose the channel. Further, the controlling unit can be used for controlling the transferring system which is used in the lid seal part-substrate part joining system to join the substrate part and the lid seal part, controlling the pressure reducing system or the pressure applying system which is used in the solution injecting system to generate a different pressure, controlling the heating system or the pressure reducing system which is used in the drying-up system, and for checking the state of sample analysis in the signal detection unit.

Next, the apparatus for microchip chemical analysis of the present invention will be explained with reference to more specific examples. Incidentally, the technical scope of the present invention is not limited to these specific embodiments.

### EIGHTH EXEMPLARY EMBODIMENT

FIG. 3 is a drawing schematically illustrating an outline of an apparatus to carry out isoelectric separation as an exemplary embodiment of the apparatus for microchip chemical analysis according to the present invention. In this eighth exemplary embodiment, a sample is chemically analyzed by isoelectric separation and, after fixing the sample and the electrophoretic liquid in the state achieved by the analysis by freeze fixation, the lid seal part is separated and removed from the substrate part. By sublimating the sample and/or the electrophoretic liquid exposed on the substrate part as a result by using the sealed vessel and the pressure reducing system, they are fixed by drying-up.

The microchip is composed of the substrate part 103 having a channel structure and the lid seal part 113 having hole structures which are to serve as a liquid reservoir.

First, the substrate part 103 is installed on a chip table along a chip guide. The chip table comprises of a Peltier device, a suction hole and a transferring system. The Peltier device is also used as a cooling system for refrigerating the microchip. The suction hole is connected to a vacuum pump, and the substrate part 103 is fixed by vacuum-chucking to the chip table. The transferring system is used as a transferring system for bringing the lid seal part and the substrate part away from each other. It has also been utilized in the lid seal part-substrate part joining system.

Next, the lid seal part 113 is installed on a lid table along a lid guide. The lid table used in this exemplary embodiment is integrated with the lid guide, and also functions as a lid seal part fixing system.

After that, a liquid reservoir lid unit is attached on the lid seal part 113. The liquid reservoir lid unit is provided with electrode parts and suction holes in its bottom face, and the electrode parts are arranged in the liquid reservoir part of the lid seal part 113. The suction holes are used for vacuum-chucking the liquid reservoir lid unit and the lid seal part 113 by reducing the pressure through the suction hole. The liquid reservoir lid unit is provided with a Peltier device which is used as the cooling system for the lid seal part when separating the liquid reservoir lid unit and the lid seal part 113 together. Further, the liquid reservoir lid unit is provided with a transferring system, which is used as a transferring system for transferring the liquid reservoir lid unit to a predetermined position, which has functions as a transferring system for bringing the lid seal part and the substrate part away from each other, and also is used as a lid seal part-substrate part joining system.

Next, the chip table, on which the substrate part 103 is installed, is lift up using the transferring system to press the substrate part 103 against the lid seal part 113, and thereby the microchip is constructed by joining. After that, the position of the chip table is kept as it is. The liquid reservoir lid unit is transferred away from above the lid seal part 113 to expose the liquid reservoir of the microchip. The electrophoretic liquid, in which the sample is dissolved, is injected into the liquid reservoir of the lid seal part 113. In particular, to carry out isoelectric focusing, 2% ampholyte (amphoteric carrier) was used as the electrophoretic liquid. When the whole channel of the microchip is filled with the electrophoretic liquid, the electrophoretic liquid remaining in the liquid reservoir is removed. Next, a cathode liquid and an anode liquid are injected into the liquid reservoirs at the two ends of the channel, and the liquid reservoir lid unit is again installed over the lid seal part 113.

All the transferring systems referred to so far can be operated by using the controlling unit.

A voltage is applied from the power source to the electrode part via wiring, and the current level between the anode and the cathode of the electrode part is measured by using the current monitoring unit. As the current level gradually drops along the duration of applying the voltage, the end of isoelectric separation can be determined if its current level or wattage can be measured.

After the isoelectric separation, the cooling systems for the chip table and the liquid reservoir lid unit are operated to freeze the sample and/or the electrophoretic liquid. Next, while attracting the chip by vacuum-chucking through the suction hole, the chip table is descended to separate the lid seal part 113 from the substrate part 103. By squeezing the lid seal part 113 from above and below together with the lid guide, the liquid reservoir lid unit operates as the lid seal part fixing device. By continuing to refrigerate the substrate part 103 with the refrigerating system for the chip table then, the frozen sample and/or electrophoretic liquid can be exposed on the substrate part 103. At this point of time, the substrate part 103 is positioned underneath the lid seal part 113. The liquid reservoir lid unit transfers to above a lid discarding unit located adjoining the chemical analyzing unit 1 in a state in which the lid seal part 113 is attracted by vacuum-chucking through the suction hole, and the lid seal part 113 is arranged on the bottom face of the lid discarding unit.

After that, the pressure in the sealed vessel is reduced through the exhaust hole which is used for evacuation of the whole sealed vessel. When the solution in the channel has finished sublimation in the reduced pressure state, the pressure reduction is stopped, and then it returns to the atmospheric pressure.

The processing so far described has proved successful in drying and fixing by freeze-fixing in the apparatus for chemical analysis the sample isoelectrically separated on the microchip and, after removing the lid to expose the sample and/or the electrophoretic liquid in the channel, freeze-drying the sample and/or the electrophoretic liquid.

### INDUSTRIAL APPLICABILITY

The automatic sample processing method for lid-sealed microchips for bioanalysis and the automatic sample processing apparatus for lid-sealed microchips for bioanalysis according to the present invention can be utilized for enhancing the improved reproducibility of process for the preparation of the sample, which is provided for further analyses, such as mass analyses and bioassay analyses, using samples being processed already by means of electrophoretic separation.

1. A method for automatically processing, after subjecting a liquid sample to be bioanalyzed to a desired operation of electrophoretic separation by utilizing a channel formed in a lid-sealed microchip, the liquid sample having gone through electrophoretic separation and held in the channel, characterized in that:
said lid-sealed microchip has a constitution in which a groove-shaped channel formed in the substrate part thereof and a lid seal part sealing the top face of the substrate part have achieved a state of being adhered together in a predetermined arrangement so that the top face of the substrate part and the bottom face of the lid seal part are tightly adhered to each other,
after completing the desired operation of electrophoretic separation of the liquid sample to be analyzed by utilizing the channel formed in the lid-sealed microchip, the method comprises the following steps:
a step of cooling in which the liquid sample having gone through electrophoretic separation and held in the channel is subjected to an operation to freeze the aqueous solvent that is contained therein by cooling the substrate part of said lid-sealed microchip to achieve a predetermined low temperature condition at or below the ice point;
a step of peeling the lid seal part off in which, while maintaining the sample having gone through electrophoretic separation in a sustained frozen state in the channel by keeping the substrate part of said lid-sealed microchip cooled to said predetermined low temperature,
an operation to peel and remove the lid seal part from the substrate part is carried out by applying an external force to an end of the lid seal part so as to release the adhesive strength which has brought the top face of the substrate part and the bottom face of the lid seal part into tight contact and achieved an adhered state in a predetermined arrangement and thereby to peel the bottom face of the lid seal part off the top face of the substrate part while maintaining a condition in which a radius of curvature R representing a local bend of the lid seal part on a boundary where the peeling is proceeding, relative to a predetermined threshold R_{eq1}, is kept smaller than said threshold R_{eq1} (R<R_{eq1}); and
a step of detaching the lid seal part in which, after said peeling step is ended, in the lid-sealed microchip, the lid seal part which has been separated from the top face of the substrate part by releasing the adhesive fixation thereto is detached, and then the separated lid seal part is subjected to an operation for conveying it away and holding so as to attain such a state that the surface of the electrophoretically separated sample in a sustained frozen state is exposed in the groove-shaped channel formed in the substrate part; and
the series of these steps being automatically accomplished.

2. An apparatus for automatically processing, after subjecting a liquid sample to be bioanalyzed to a desired operation of electrophoretic separation by utilizing a channel formed in a lid-sealed microchip, the liquid sample having gone through electrophoretic separation and held in the channel, characterized in that:
said lid-sealed microchip has a constitution in which a groove-shaped channel formed in the substrate part thereof and a lid seal part sealing the top face of the substrate part have achieved a state of being adhered together in a predetermined arrangement so that the top face of the substrate part and the bottom face of the lid seal part are tightly adhered to each other,
the apparatus comprises the following systems to be provided for the lid-sealed microchip in which the desired operation of electrophoretic separation of the liquid sample to be analyzed has been completed by utilizing the channel formed in the lid-sealed microchip: a system for refrigerating the substrate part, which system is adapted for installation in an arrangement in contact with the substrate part of said lid-sealed microchip;
a control unit for the refrigerating system, which unit is capable of maintaining at least the substrate part in a predetermined low temperature condition of at or below the ice point by cooling down by means of the system for refrigerating the substrate part to be installed in the arrangement in contact with the substrate part;
a system for fixing the substrate part, which system is capable of fixing the substrate part of said lid-sealed microchip in the arrangement in contact with said system for refrigerating the substrate part;
a system for imposing an external force, which system has a function to impose on an end of the lid seal part an external force having a substantially perpendicular direction to the top face of the substrate part in the arrangement in which the substrate part is fixed by said system for fixing the substrate part in order to release the adhesive strength which has brought the top face of the substrate part and the bottom face of the lid seal part into tight contact and achieved an adhered state in a predetermined arrangement;
a system for transferring the end of the lid seal part, which system is capable of transferring the end of the lid seal part in a direction substantially perpendicular to the boundary of contact between the top face of the substrate part and the bottom face of the lid seal part in synchronism with the imposition of the external force on the end of the lid seal part by said system for imposing the external force;
a system for controlling a speed of transferring the end of the lid seal part, which has a function to control the transfer speed of the end of the lid seal part so that, in the process of peeling the bottom face of the lid seal part off the top face of the substrate part by using the system for transferring the end of the lid seal part and the system for imposing the external force, which systems works in synchronism on the end of said lid seal part, a radius of curvature R representing a local bend of the lid seal part on a boundary where the peeling is proceeding is maintained in such condition that, relative to a predetermined threshold R_{eq1}, the radius of curvature R is kept smaller than said threshold R_{eq1} (R<R_{eq1});
a system for detaching the separated lid seal part, which system has such a function that, after the operation to peel the lid seal part off the top face of the substrate part is ended, the system holds the lid seal part which is separated from the top face of the substrate part by releasing the adhesive fixation and conveys it away from the top face of the substrate part so as to expose the groove-shaped channel formed in the substrate part; and
the apparatus further comprises a system for controlling an automatic operation thereof, which system has a function to cause the actions of each of the systems accomplishing the series of operations set forth to be automatically accomplished in accordance with a predetermined process program.

3. A method for analyzing bio-sample, which is a method in which, after subjecting a liquid sample to be bio-analyzed to a desired operation of electrophoretic separation by utilizing a channel formed in a lid-sealed microchip, regarding ingredient substances being spot-separated on said channel, which are contained in the electrophoretically separated liquid sample held on the channel formed in the lid-sealed microchip, mass analysis of the ingredient substances spot-separated is carried out, characterized in that:
said lid-sealed microchip has a constitution in which a groove-shaped channel formed in the substrate part thereof and a lid seal part sealing the top face of the substrate part have achieved a state of being adhered together in a predetermined arrangement so that the top face of the substrate part and the bottom face of the lid seal part are tightly adhered to each other,
the method comprising:
a step of collection, in which, after completing the desired operation of electrophoretic separation of the liquid sample to be analyzed by utilizing the channel formed in the lid-sealed microchip,
the lid seal part, with which the top face of the substrate part is tightly covered by sealing, is peeled and removed out in accordance with the method for automatic sample processing for lid-sealed microchips for bio-analysis as claimed in claim 1, and then
the electrophoretically separated sample, which is maintained in a sustained frozen state in the groove-shaped channel formed in the substrate part whose surface is exposed thereby, is collected;
a step for lyophilization and fixing, in which the electrophoretically separated sample maintained in the sustained frozen state in the groove-shaped channel formed in the substrate part is subjected to lyophilization to fix each of the ingredient substances, which is separated at each point of spots on said channel formed in the substrate part, in the form of freeze-dried matters on the pertinent spots;
a step for providing a matrixing agent, in which the matrixing agent used for MALDI-MS analysis is coated on the groove-shaped channel formed in the substrate part to provide said matrixing agent to the electrophoretic separated ingredient substances, fixed on the spots in the form of freeze-dried matters;
a step for MALDI-MS analyzing, in which MALDI-MS analytical operation along the groove-shaped channel formed in the substrate part is carried out by using said matrixing agent to acquire molecular weight information on ion species deriving from the electrophoresized ingredient substances fixed in the form of freeze-dried matters on the pertinent spots and positional information on the spots showing the molecular weight information of the ion species, and
a step for data analyzing, in which specifying electrophoretic index values corresponding to the spots is carried out on the basis of the acquired positional information for the spots showing the molecular weight information of the ion species, and then the information is converted into combinations of the specified electrophoretic index values specified and the molecular weight information of ion species measured at the pertinent spots, which are presumably derived from the ingredient substances contained in the liquid sample to be analyzed, being located along the groove-shaped channel.

4. The method according to claim 1,
wherein the electrophoretic separating operation is isoelectric focusing.

5. The apparatus according to claim 2,
wherein the electrophoretic separating operation is isoelectric focusing.

6. The method according to claim 3,
wherein the electrophoretic separating operation is isoelectric focusing.

7. A method for automatic sample processing characterized by,
after completing the process for removing a lid seal part
in accordance with the method for automatic sample processing for lid-sealed microchips for bio-analysis as claimed in claim 1,
the method further comprises:
a step for lyophilization and fixing, in which the electrophoretically separated sample maintained in the sustained frozen state in the groove-shaped channel formed in the substrate part is subjected to lyophilization to fix each of the ingredient substances, which is separated at each point of spots on said channel formed in the substrate part, in the form of freeze-dried matters on the pertinent spots.

8. An apparatus for automatic sample processing characterized in that:
in addition to each of systems included in the apparatus for automatic sample processing for lid-sealed microchips for bioanalysis as claimed in claim 2,
the apparatus further comprises,
a system for lyophilization and fixing, with use of which system, the electrophoretically separated sample maintained in the sustained frozen state in the groove-shaped channel formed in the substrate part is subjected to lyophilization in a state in which the groove-shaped channel formed in the substrate part is exposed by conveying the separated lid seal part away from the top face of the substrate part by using the system for detaching the lid seal part, so that each of the ingredient substances, which is separated at each point of spots on said channel formed in the substrate part, is fixed in the form of freeze-dried matters on the pertinent spots.
